(19) United States
(12) Patent Application Publication
(10) Pub. No.: US 2011/0056230 A1
(43) Pub. Date: Mar. 10, 2011

(54) PERSONALIZABLE SPORTS THEMED ICE CHEST, AND METHODS OF CONSTRUCTING AND UTILIZING SAME

(76) Inventor: KEN BLAKEMAN, Las Vegas, NV (US)

(21) Appl. No.: 12/573,104

(22) Filed: Oct. 3, 2009

Related U.S. Application Data
(63) Continuation-in-part of application No. 29/343,089, filed on Sep. 7, 2009, now Pat. No. D613128.

(51) Int. Cl. F25D 23/12; F25D 3/08; B65D 25/28; G11B 31/00

(52) U.S. Cl. 62/331; 62/457.7; 220/757; 369/63; G9B/31

(57) ABSTRACT

A personalizable sports themed ice chest having a main ice chest housing and a selectively openable and closable lid member pivotably secured to the housing. The ice chest has a personalizable sports related shape, wheels rotatably secured to the housing, a collapsible pull handle mechanism connected to the housing, and areas on the housing and lid member for the placement of a logo or emblem.

### CROSS-REFERENCE TO RELATED APPLICATIONS

This application is a continuation-in-part of and claims priority from US Design Patent Application 29/343,089 filed Sep. 7, 2009.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The phrase “sports related shape” as used herein means any one of various sports related shapes, including, but not limited to, a football, a soccer ball, a baseball, a golf ball, a race car driver's helmet, stacked tires, and a football helmet.

The phrase “a renewable resource” as used herein means any renewable resource, including, but not limited to, corn sugar or a fibrous residue remaining after sugarcane or sorghum stalks are crushed to extract their juice.

The present invention relates to a novel and unique personalizable sports themed ice chest, and methods of constructing and utilizing same.

More particularly, the present invention relates to a novel and unique personalizable sports themed ice chest fabricated from a renewable resource, and methods of constructing and utilizing same.

It is a desideratum of the present invention to avoid the animadversions of conventional ice chests, and at the same time to provide a very convenient and unique personalizable sports themed ice chest.

### SUMMARY OF THE INVENTION

The present invention provides a personalizable sports themed ice chest, comprising: a main ice chest housing having a selectively openable and closable lid member pivotably secured to said main ice chest housing; said main ice chest housing and said selectively openable and closable lid member being formed in a personalizable sports related shape; wheels rotatably secured to said main ice chest housing under said main ice chest housing to enable said personalizable sports themed ice chest to be rolled by a user of said personalizable sports themed ice chest; a collapsible pull handle mechanism connected to said main ice chest housing; and one or more predetermined areas for the placement thereon of a logo or emblem.

It is a primary object of the present invention to provide a personalizable sports themed ice chest.

Another object of the present invention is to provide a novel and unique personalizable sports themed ice chest fabricated from a renewable resource, and methods of constructing and utilizing same.

A further object of the present invention is to provide an ice chest as described above which includes a mini recorder within the lid compartment.

Yet another object of the present invention is to provide an ice chest as described above which includes speakers built into the ice chest lid.

Yet another object of the present invention is to provide an ice chest as described above which includes a collapsible pull handle mechanism connected to the main ice chest housing, and one or more predetermined areas on the main ice chest housing for the placement thereon of a personalizable logo or emblem.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a perspective view of a first embodiment of the present invention.

FIG. 2 is a top plan view of the apparatus depicted in FIG. 1.

FIG. 3 shows the underside of the lid.

FIG. 4 is a front elevational view of the FIG. 1 apparatus.

FIG. 5 is a cross-sectional view of the apparatus with the handle fully collapsed.

FIG. 6 is a rear elevational view of the FIG. 1 apparatus.

FIG. 7 is a side elevational view with the lid partially open.

FIG. 8 is a perspective view of a second embodiment of the present invention.

FIG. 9 is a top plan view of the FIG. 8 apparatus.

FIG. 10 is bottom view of the FIG. 8 apparatus.

FIG. 11 is front elevational view of the FIG. 8 apparatus.

FIG. 12 is right side elevational view of the FIG. 8 apparatus.

FIG. 13 is rear elevational view of the FIG. 8 apparatus.

FIG. 14 is left side elevational view of the FIG. 8 apparatus.

### DETAILED DESCRIPTION OF THE INVENTION

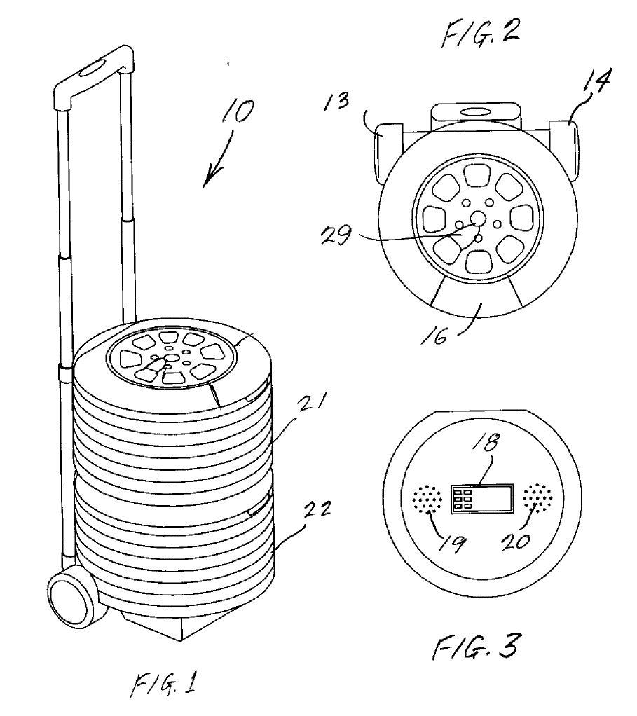

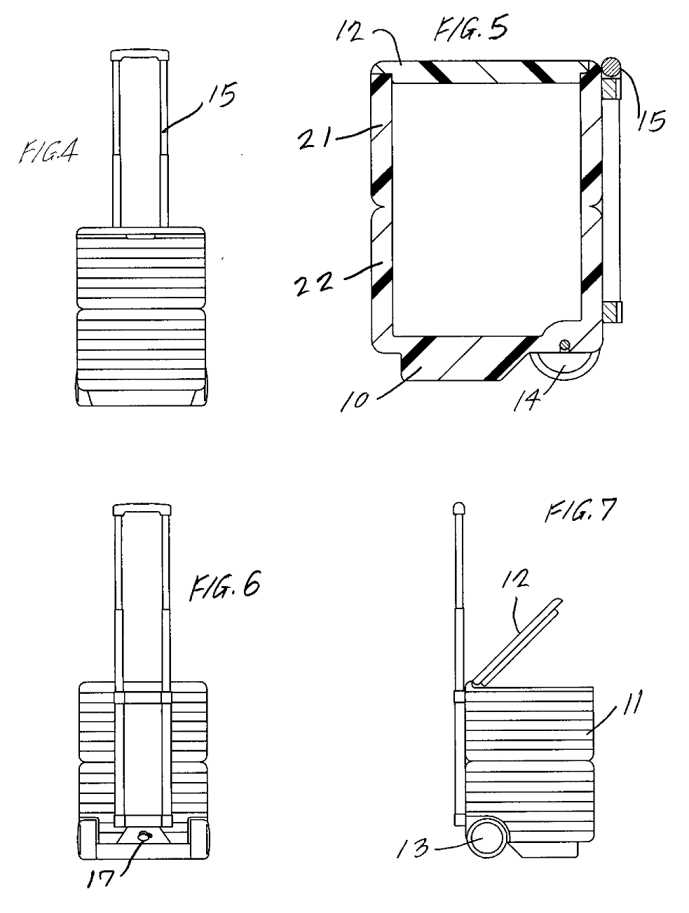

With reference to FIGS. 1-7, there is shown a personalizable sports themed ice chest 10 in accordance with a first embodiment of the invention.

The chest 10 includes a main ice chest housing 11 having a selectively openable and closable lid member 12 pivotably secured to the main ice chest housing 11.

The main ice chest housing 11 and said selectively openable and closable lid member 12 are formed in a personalizable sports related shape, which in this case are stacked tires 21 and 22 for a user interested in the sport of auto racing.

Wheels 13 and 14 rotatably secured to said main ice chest housing 11 under said main ice chest housing 11 to enable said personalizable sports themed ice chest 10 to be rolled by a user of said personalizable sports themed ice chest 10.

A collapsible pull handle mechanism 15 is connected to said main ice chest housing 11.

There are provided one or more predetermined areas 16 and 29 for the placement thereon of a personalizable logo or emblem (not shown).

Fabrication may be of standard commercially-available ice chest material.

Alternatively, the main ice chest housing 11, the selectively openable and closable lid member 12, the handle 15, the wheels 13 and 14, insulation and other components may be fabricated from a renewable resource.

More particularly, the main ice chest housing 11 and said selectively openable and closable lid member 12 may be fabricated from a renewable resource, for example, such as corn sugar or a fibrous residue remaining after sugarcane or sorghum stalks are crushed to extract their juice.

A drain 17 is provided at the bottom of said main ice chest housing 11.

A digital recorder 18 may be provided on the underside of said selectively openable and closable lid member 12.

The digital recorder 18 may be provided with preset messages and the ability for the user of said personalizable sports themed ice chest 10 to record additional messages on said digital recorder 18.

One or more speakers 19 and 20 may be provided on the underside of said selectively openable and closable lid member 12.

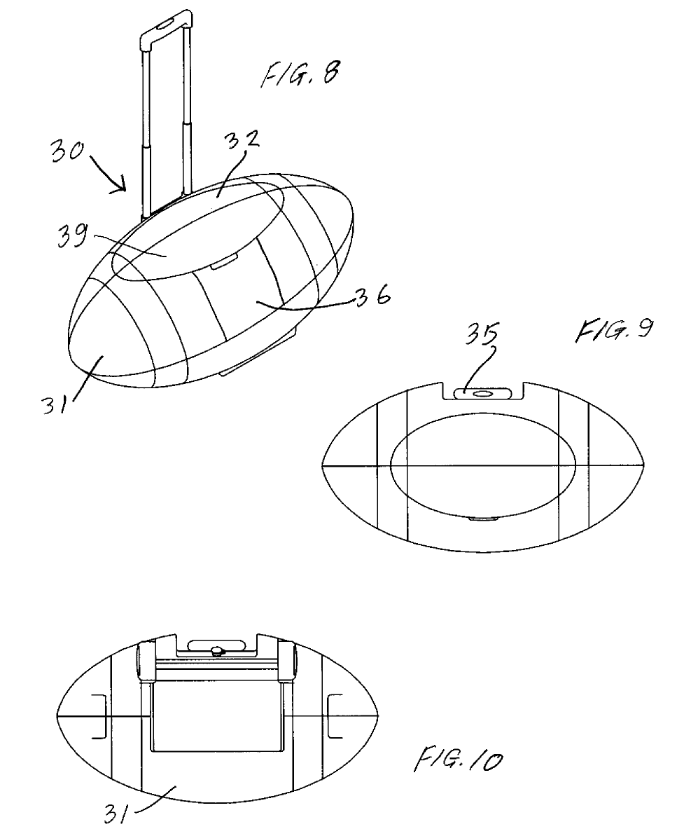

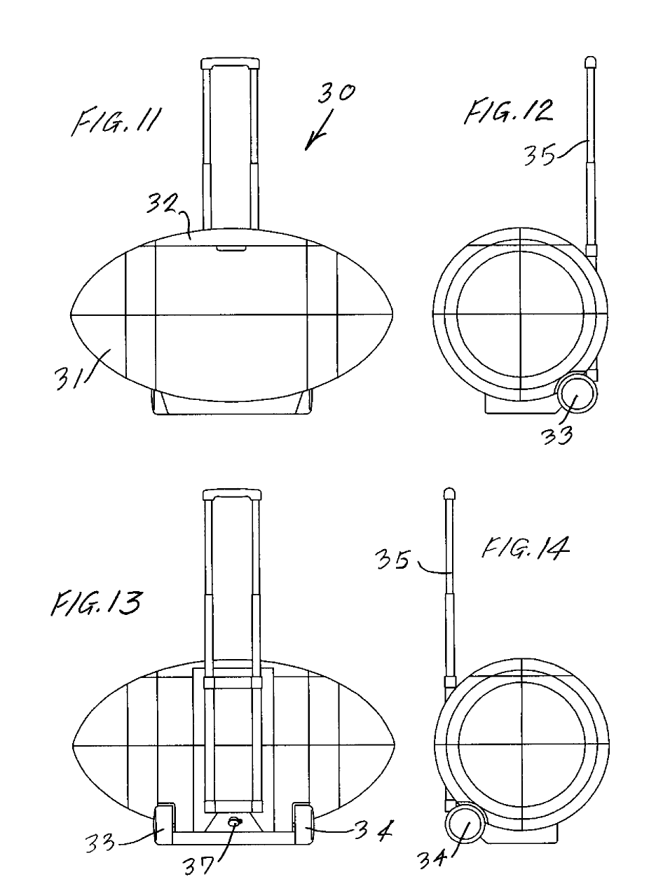

With reference to FIGS. 8-14, there is shown a personalizable sports themed ice chest 30 in accordance with a second embodiment of the invention.

The chest 30 includes a main ice chest housing 31 having a selectively openable and closable lid member 32 which is pivotably secured to the main ice chest housing 31.

The main ice chest housing 31 and said selectively openable and closable lid member 32 are formed in a personalizable sports related shape, which in this case is the shape of a football.

Wheels 33 and 34 are rotatably secured to said main ice chest housing 31 under said main ice chest housing 31 to enable said personalizable sports themed ice chest 30 to be rolled by a user of said personalizable sports themed ice chest 30.

A collapsible pull handle mechanism 35 is connected to said main ice chest housing 31.

There is provided one or more predetermined areas 36 and 39 for the placement thereon of a personalizable logo or emblem (not shown), such as a logo of the favorite football team of the user.

Fabrication may be of standard commercially-available ice chest material.

Alternatively, the main ice chest housing 31 and said selectively openable and closable lid member 32 may be fabricated from a renewable resource.

More particularly, the main ice chest housing 31, the selectively openable and closable lid member 32, the handle 35, the wheels 33 and 34, insulation and other components may be fabricated from a renewable resource, for example, such as corn sugar or a fibrous residue remaining after sugarcane or sorghum stalks are crushed to extract their juice.

A drain 37 is provided at the bottom of said main ice chest housing 31.

A digital recorder (not shown in FIGS. 8-14, but similar to the recorder 18 shown in FIG. 3) may be provided on the underside of said selectively openable and closable lid member 32.

The digital recorder may be provided with preset messages and the ability for the user of said personalizable sports themed ice chest 30 to record additional messages on said digital recorder.

One or more speakers (not shown in FIGS. 8-14, but similar to the speakers 19 and 29 shown in FIG. 3) may be provided on the underside of said selectively openable and closable lid member 32.

There have been illustrated in the accompanying drawings and described hereinabove only two possible unique and novel embodiments of the present invention which can be practiced and constructed in many different embodiments, configurations, materials, arrangements of components, sizes, and shapes.

It should be understood that many changes, modifications, variations, and other uses and applications will become apparent to those persons skilled in this particular area of technology and to others after having been exposed to the present patent specification and accompanying drawings.

Any and all such changes, modifications, variations and other uses and applications which do not depart from the spirit and scope of the present invention are therefore covered by and embraced within the present invention and the patent claims set forth hereinbelow.

1. A personalizable sports themed ice chest, comprising:
a main ice chest housing having a selectively openable and closable lid member pivotably secured to said main ice chest housing;
said main ice chest housing and said selectively openable and closable lid member being formed in a personalizable sports related shape;
wheels rotatably secured to said main ice chest housing under said main ice chest housing to enable said personalizable sports themed ice chest to be rolled by a user of said personalizable sports themed ice chest;
a collapsible pull handle mechanism connected to said main ice chest housing; and
one or more predetermined areas for the placement thereon of a logo or emblem.

2. The personalizable sports themed ice chest of claim 1, wherein:
said main ice chest housing and said selectively openable and closable lid member are fabricated from a renewable resource; and
a drain is provided at the bottom of said main ice chest housing.

3. The personalizable sports themed ice chest of claim 1, wherein:
one or more speakers are provided on the underside of said selectively openable and closable lid member.

4. The personalizable sports themed ice chest of claim 2, wherein:
one or more speakers are provided on the underside of said selectively openable and closable lid member.

5. The personalizable sports themed ice chest of claim 1, including:
a digital recorder provided on the underside of said selectively openable and closable lid member.

6. The personalizable sports themed ice chest of claim 2, including:
a digital recorder provided on the underside of said selectively openable and closable lid member.

7. The personalizable sports themed ice chest of claim 3, including:
a digital recorder provided on the underside of said selectively openable and closable lid member.

8. The personalizable sports themed ice chest of claim 4, including:
a digital recorder provided on the underside of said selectively openable and closable lid member.

9. The personalizable sports themed ice chest of claim 5, wherein:
said digital recorder is provided with preset messages and the ability for the user of said personalizable sports themed ice chest to record additional messages on said digital recorder.

10. The personalizable sports themed ice chest of claim 6, wherein:
said digital recorder is provided with preset messages and the ability for the user of said personalizable sports themed ice chest to record additional messages on said digital recorder.

11. The personalizable sports themed ice chest of claim 7, wherein:
said digital recorder is provided with preset messages and the ability for the user of said personalizable sports themed ice chest to record additional messages on said digital recorder.

12. The personalizable sports themed ice chest of claim 8, wherein:
said digital recorder is provided with preset messages and the ability for the user of said personalizable sports themed ice chest to record additional messages on said digital recorder.

13. The personalizable sports themed ice chest of claim 2, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.

14. The personalizable sports themed ice chest of claim 4, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.

15. The personalizable sports themed ice chest of claim 6, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.

16. The personalizable sports themed ice chest of claim 5, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.

17. The personalizable sports themed ice chest of claim 7, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.

18. The personalizable sports themed ice chest of claim 8, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.

19. The personalizable sports themed ice chest of claim 10, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.

20. The personalizable sports themed ice chest of claim 12, wherein:
said main ice chest housing, said selectively openable and closable lid member, said wheels, and said handle mechanism are fabricated from a renewable resource which is corn sugar or a fibrous residue remaining after sugarcane or sorghum stalks are crushed to extract their juice.
